(19) United States
(12) Patent Application Publication
(10) Pub. No.: US 2013/0277296 A1
(43) Pub. Date: Oct. 24, 2013

(54) Pre-Filter Water Cleaner

(71) Applicants: Robert D. Deeds, El Dorado, AR (US); Betty Jo Black, El Dorado, AR (US)

(72) Inventors: Robert D. Deeds, El Dorado, AR (US); Betty Jo Black, El Dorado, AR (US)

(21) Appl. No.: 13/454,991

(22) Filed: Apr. 24, 2012

(51) Int. Cl. B01D 35/00; B01D 21/00

(52) U.S. Cl. 210/248

(57) ABSTRACT

A pre-filter apparatus adaptable to increase life of a water purification unit comprises a water holding unit having a top cap and a bottom cap, a connector positioned at one-third length of the water holding unit, a water inlet unit located on the connector, a water outlet unit located on the top cap and a sediment drain positioned on a lower portion of the water holding unit. The sediment drain is capable of collecting sediments from water. The water inlet unit is adaptable to receive water from an external water supply source. The pre-filter apparatus is positioned between the external water supply source and the water purification unit. The pre filter apparatus helps to remove sediments from water supplied by the external water supply source prior to filtration so as to extend life of the water purification unit.

### CROSS-REFERENCE TO RELATED APPLICATION

Not Applicable

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

This invention relates to pre-filters, and more particularly to a pre-filter apparatus for extending the life of water purification units.

Pure water is required for various purposes such as drinking water, and water used in medical, pharmacology, chemical and industrial applications. Pre-filters are used to remove contaminants such as sand, dust, undesirable chemicals, suspended particles and a range of dissolved and particulate material from contaminated water prior to filtration. The pre-filters are required to filter water from external water supply sources such as wells, rivers or sumps prior to filtration by filters. Pre-filters are often positioned between external water supply sources and water purification units. There are several types of pre-filters which work using different methods. The choice of method will depend upon the quality of the water being treated, the cost of the water treatment, and the required quality standards of the processed water.

In U.S. Pat. No. 6,042,733 issued to Tucker on Mar. 28, 2000 a sediment filtering apparatus and a method for removing sediment from a waterway is disclosed. One or more collector assemblies are secured to a river bottom and have a leading ramp surface facing upstream over which the water flows. As the water/sediment mixture passes the apex of the collector, the trailing edge drops off rapidly thereby reducing the stream velocity and allowing the sediment from the flow to settle. The sediment then collects on the downstream side of the collector, and via one or more openings, reaches an internal cavity. A suction pipe is placed under negative pressure and draws the water/sediment mixture to a filtering apparatus which then returns filtered water to the waterway. The sediment and debris filtered therefrom is then easily removed from the water way.

U.S. Pat. No. 6,010,624 issued to Larsen on Jan. 4, 2000 discloses a system and method for the treatment of contaminated sediment found in rivers, lakes and certain bodies of water. In this system, the contaminated sediment is removed from the body of water as part of a liquefied mixture including both water and the contaminated sediment. The water is separated from the contaminants by treating the sediment through the introduction of a solidifying compound, certain specified sorbents and a cementitious material. The result is a solidification of the treated contaminants into a solid structural configuration which facilitates the disposal of the resulting solidified contaminants at an appropriate landfill site.

U.S. Pat. No. 5,900,149 issued to Bradford on May 4, 1999 describes a sedimenter for use in separating relatively dense contaminants from a flow of fuel. The sedimenter comprises a housing having an inlet and an outlet, the housing contains a contaminant collection chamber and a sedimentation chamber. The collection chamber is located beneath and connects with the sedimentation chamber. The flow path is located within the sedimentation chamber and forces the fuel flowing between the inlet and the outlet to follow a tortuous flow path of relatively great length. The spiral-shaped flow path in the sedimentation chamber reduces the risk of water and other contaminants already separated from the fuel from reaching the outlet as a result of vehicle motion.

All of the systems and methods discussed above have considerable drawbacks for providing filtration. All the conventional filters discussed above require complex filtration processes to purify water or fuel which results in complexity for the user. These filters require more time for the sediment to settle to the bottom. In addition, the filters include moving parts that increase the chances for wear and tear, and potential breakdowns.

Therefore, there is a need for a simple, easy to manufacture pre-filter apparatus that can be used to filter water from any external water supply source. Such a needed apparatus would easily remove the sediment from water to enhance filtration within a short time, and extend the life of the filtration unit. Such an apparatus would be easily installed by the user. The present apparatus accomplishes these objectives.

### SUMMARY

The preferred embodiment in accordance with the present invention is a pre-filter apparatus adaptable to increase the life of a water purification unit. The pre-filter apparatus comprises a water holding unit that is empty having a top cap and a bottom cap, a connector positioned at one-third length of the water holding unit, a water inlet unit located on the connector, a water outlet unit located on the top cap and a sediment drain positioned on a lower portion of the water holding unit. The sediment drain is capable of collecting sediments from water. The water inlet unit is adaptable to receive water from an external water supply source. The connector is employed to strengthen the water holding unit. The water inlet unit includes a water inlet opening to connect the water inlet unit to the external water supply source by means of a pipe thread. The water outlet unit includes a water outlet opening to connect the water outlet unit to the water purification unit by means of a pipe thread. The sediment drain includes a drain opening to connect the sediment drain to a foot tube by means of a pipe thread. When water enters the water inlet unit from an external water supply source, pressure from the external water supply source forces water inside the pre-filter water apparatus forcing the water to exit through the water outlet unit located at the top of the pre-filter apparatus. Gravity causes heavy sediments in the water to fall downward, collecting in the sediment drain, while lighter sediment may be forced out through the water outlet unit to be filtered by a water purification unit. In this way, the pre filter apparatus helps to remove sediments from water supplied by the external water supply source prior to filtration so as to extend the life of the water purification unit.

A method for increasing life of a water purification unit utilizing a pre-filter apparatus is initiated by positioning the pre-filter apparatus having a water inlet unit, a water holding unit, a water outlet unit, a connector and a sediment drain between an external water supply source and the water purification unit. Water from the external water supply source is allowed to enter the pre-filter apparatus through the water inlet unit. Then, the water is allowed to flow from the water inlet unit to the water holding unit. The water inlet unit is closed to stop the flow of water from the external water supply source. The sediments are then allowed to settle down in the sediment drain positioned on a lower portion of the water holding unit. Finally, clear water at the top of the pre-filter apparatus is allowed to flow through the water outlet unit to the water purification unit.

### BRIEF DESCRIPTION OF THE FIGURES

FIG. 1A is a perspective view of a pre-filter apparatus adaptable to increase the life of a water purification unit. FIG. 1B is a perspective view of a pre-filter apparatus filled with sediments.

FIG. 2 is a flow chart illustrating a method for increasing the life of a water purification unit utilizing a pre-filter apparatus.

FIG. 3 is a perspective view of the present invention, illustrating the pre-filter apparatus in use.

### REFERENCE NUMERALS

10 . . . Pre-filter apparatus
12 . . . Water holding unit
14 . . . Top cap
16 . . . Bottom cap
18 . . . Connector
20 . . . Water inlet unit
22 . . . Water outlet unit
24 . . . Sediment drain
26 . . . Lower portion of the water holding unit
28 . . . Water inlet opening
30 . . . Water outlet opening
32 . . . Drain opening
34 . . . Positioning the pre-filter apparatus having a water inlet unit, a water holding unit, a water outlet unit, a connector and a sediment drain between an external water supply source and the water purification unit
36 . . . Allowing water from the external water supply source to enter the pre-filter apparatus through the water inlet unit
38 . . . Allowing the water to flow from the water inlet unit to the water holding unit
40 . . . Closing the water inlet unit to stop flow of water from the external water supply source
42 . . . Allowing the sediments to settle down in the sediment drain positioned on a lower portion of the water holding unit
44 . . . Allowing clear water at top of the pre-filter apparatus to flow through the water outlet unit to the water purification unit
46 . . . Water purification unit
48 . . . Connecting pipe
50 . . . Foot tube
52 . . . Bucket
54 . . . Heavy sediments
56 . . . Light sediments

### DETAILED DESCRIPTION

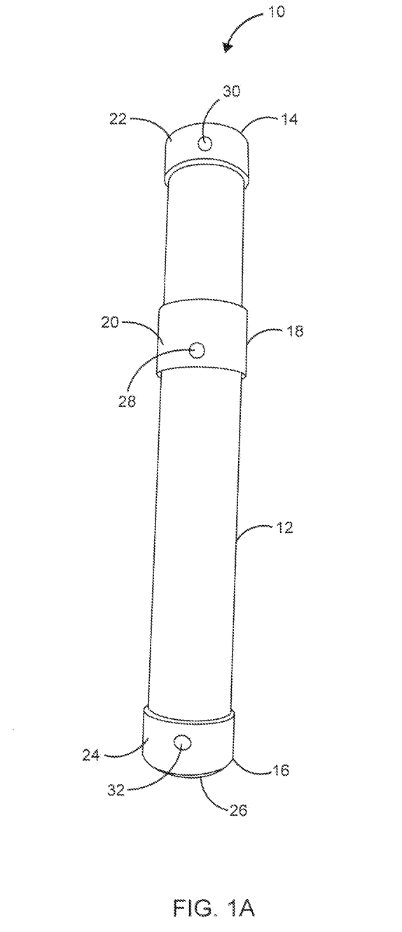

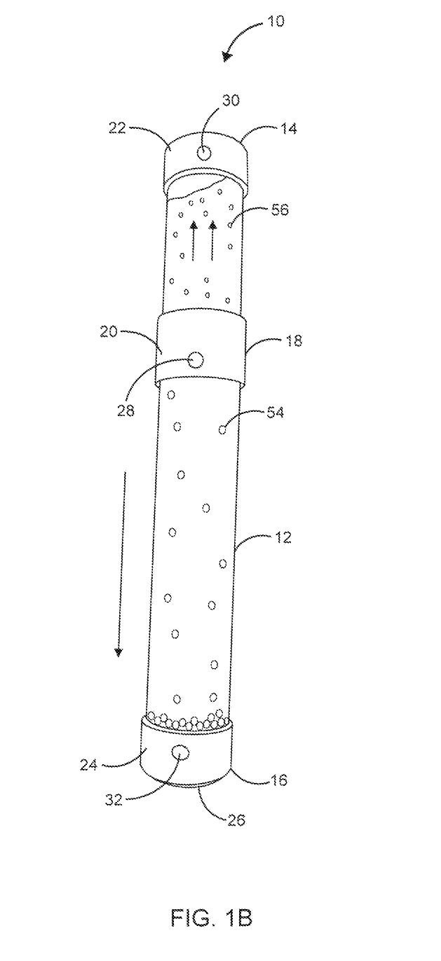

FIG. 1A shows a perspective view of a pre-filter apparatus 10 adaptable to increase the life of a water purification unit (not shown). The pre-filter apparatus 10 comprises a water holding unit 12 having a top cap 14 and a bottom cap 16, a connector 18 positioned at one-third length of the water holding unit 12, a water inlet unit 20 located on the connector 18, a water outlet unit 22 located on the top cap 14, and a sediment drain 24 located on the bottom cap 16. The sediment drain 24 is capable of collecting sediments from water. The water inlet unit 20 is adaptable to receive water from an external water supply source (not shown). The connector 18 is employed to strengthen the water holding unit 12. The water inlet unit 20 includes a water inlet opening 28 to connect the water inlet unit 20 to the external water supply source by means of a pipe thread (not shown). The water outlet unit 22 includes a water outlet opening 30 to connect the water outlet unit 22 to the water purification unit 46 by means of a pipe thread. The sediment drain 24 includes a drain opening 32 to connect the sediment drain 24 to a foot tube 50 by means of a pipe thread. As seen in FIG. 1B, when water enters the water inlet unit 20 from an external water supply source (not shown), pressure from the external water supply source (not shown) forces water inside the pre-filter water apparatus 10 forcing the water to exit through the water outlet unit 22 located at the top of the pre-filter apparatus. From a well, for example, the amount of pressure is 30-50 psi. Water from the well travels approximately four inches until it makes contact with the inner wall surface of the pre-filter water apparatus 10. This causes a great deal of turbulence, causing the water and sediment to scatter in all directions. Gravity causes heavy sediments 54 in the water to fall downward instantly, collecting in the sediment drain 24, while light sediment 56 may be forced out through the water outlet unit 22 to be filtered by a water purification unit 46. The water purification unit 46 filters out the remaining light sediment 56 and clear water enters a home through a faucet. Moreover, when the faucet is shut off, the lighter sediment 56 still remaining in the pre-filter water apparatus 10 also falls downward and collects in the sediment drain 24. The water remaining in the pre-filter water apparatus 10 then becomes clear. In this way, the pre filter water apparatus 10 helps to remove sediments from water supplied by the external water supply source (not shown) prior to filtration so as to extend the life of the water purification unit. Up to 50% of sediment from an external water source can be removed from water before the water reaches a water purification unit 46.

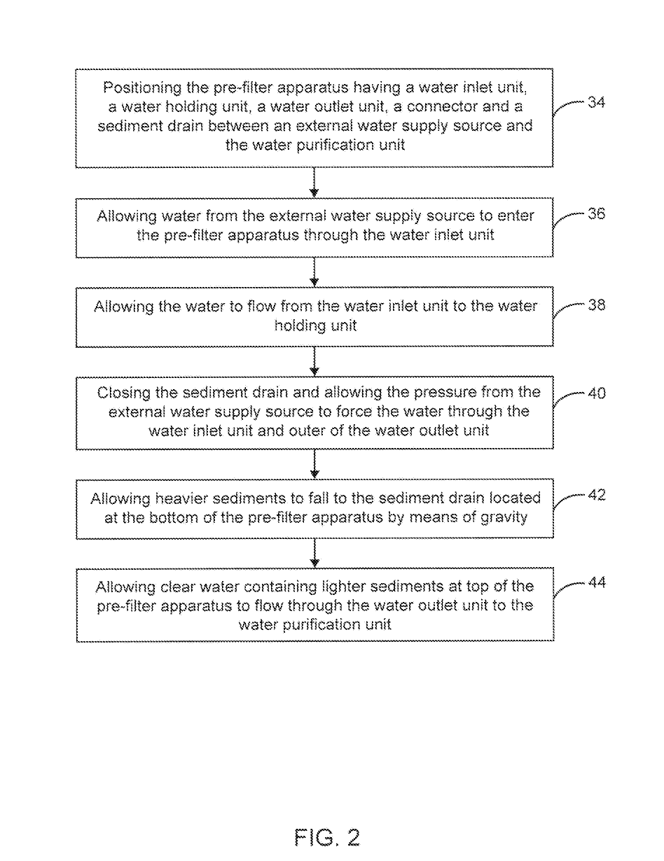

FIG. 2 is a flow chart illustrating a method for increasing the life of a water purification unit utilizing a pre-filter apparatus. Initially, the pre-filter apparatus having a water inlet unit, a water holding unit, a water outlet unit, a connector and a sediment drain is positioned between an external water supply source and the water purification unit as indicated at block 34. Next, water from the external water supply source is allowed to enter the pre-filter apparatus through the water inlet unit as shown in block 36. Then, the water is allowed to flow from the water inlet unit to the water holding unit as indicated at block 38. As shown in block 40, the sediment drain is closed and pressure from the external water supply source forces the water through the water inlet unit and upward and out of the water outlet unit. Gravity causes heavier sediments to fall to the sediment drain at the bottom of the pre-filter apparatus as indicated at block 42. Clearer water at the top of the pre-filter apparatus, which may contain lighter sediments, is allowed to flow through the water outlet unit to the water purification unit as shown in block 44. When the sediment drain is full, the heavy sediments may be expelled through a drain opening.

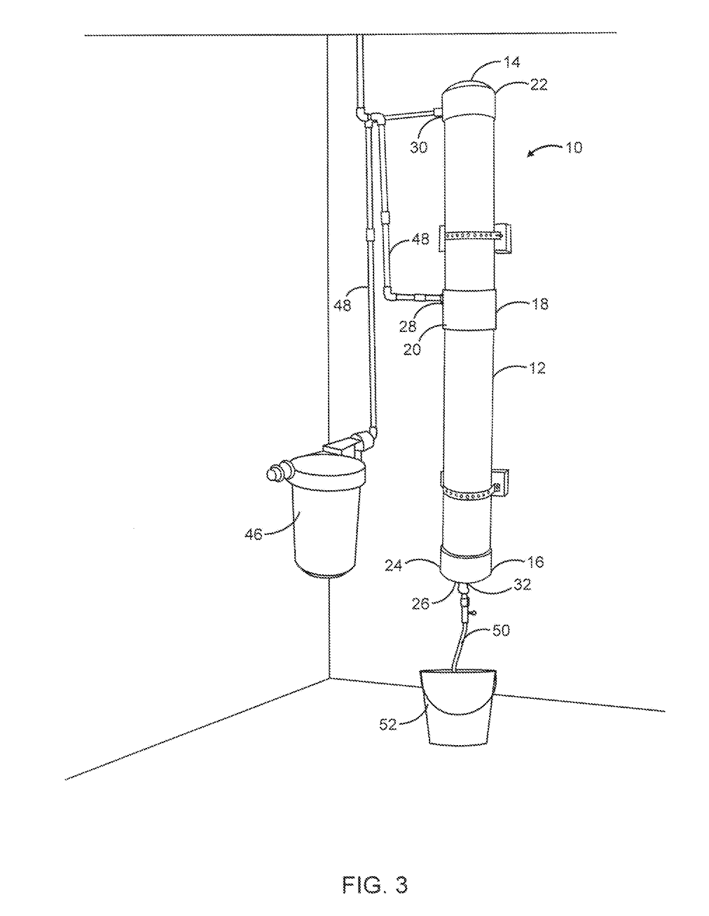

FIG. 3 is a perspective view of the preferred embodiment of the pre-filter apparatus 10 in use. The pre-filter apparatus 10 is positioned between the external water supply source (not shown) and the water purification unit 46. The external water supply source may be a well, a river or a sump. The water purification unit 46 may be a water filter. The water inlet unit 20 is positioned at one third length of the water holding unit 12. The water holding unit 12 is a single Poly Vinyl Chloride (PVC) pipe. Ideally, the pre-filter apparatus should be placed vertically, with the water inlet unit 20 positioned below the water outlet unit 22 and the sediment drain 24 positioned below the water inlet unit 20. In this way, water enters the water inlet unit 20 from an external water supply source, and the pressure from said external water supply source forces the water to exit upwardly and out of the water outlet unit. Gravity, however, forces heavier sediments to fall downward to the sediment drain disposed below the water inlet unit 20. The water inlet opening 28 is connected to the external water supply source by means of a connecting pipe 48 utilizing the pipe thread. The water outlet opening 30 is connected to the water purification unit 46 by means of the connecting pipe 48 utilizing the pipe thread. The pre-filter apparatus 10 can be rotated to 180° to fit the pipe thread as long as the water inlet unit 20 is still below the water outlet unit and the sediment drain is positioned below the water inlet unit 20. The water inlet opening 28, the water outlet opening 30 and the drain opening 32 may be ¾″ threaded openings and the pipe thread may be ¾″ pipe thread. When the drain opening 32 is closed, heavier sediments contained in the water will settle down at the sediment drain 24. This will occur as long as there is water in the pre-filter water apparatus. Heavy sediments 54 collected in the sediment drain 24 will flow down through the foot tube 50 to a bucket 52. The sediments thus collected in the bucket 52 may be utilized for gardening purposes. Clearer water at the top of the apparatus 10 is then allowed to flow into the water purification unit 46 through the water outlet unit 22. The process can be repeated based on the nature of the water need to be pre-filtered.

The pre-filter apparatus 10 helps to increase the life of the water purification unit 46. The efficiency of the apparatus 10 may be further increased by employing larger water holding unit 12. The apparatus 10 is made of health department approved materials. The pre-filter apparatus 10 is easy to manufacture and is of low cost. Since the apparatus 10 has no moving parts, there is less chance for wear and tear. In addition, the apparatus 10 provides an ease of usage since it can be mounted anywhere between the water purification unit 46 and the external water supply source. Also, the apparatus 10 is capable of collecting more than 50% of heavy sediments. The pre-filter apparatus 10 also helps to save money on filters since the filters employed with this apparatus do not require frequent replacements. In an alternate embodiment, the pre-filter apparatus 10 may employ an electric timer for easy purging.

The pre-filter apparatus 10 can be made of regular PVC pipes or stainless steel.

1. A pre-filter water apparatus comprising:
a water holding unit comprising a water inlet unit located below a water outlet unit, and a sediment drain located below the water inlet unit, the water inlet unit adapted to receive water from an external water supply source and the water outlet unit adapted to transfer water to a water purification unit; and
further comprising a water holding unit having a top cap and a bottom cap, which together define an empty chamber;
whereby the pre-filter water apparatus removes a portion of sediment from water supplied by the external water supply source prior to filtration by the water purification unit so as to extend the life of the water purification unit.

2. The pre-filter water apparatus of claim 1, wherein the water outlet unit is disposed on the top cap, the water inlet unit is disposed on the water holding unit, and a sediment drain is disposed on the bottom cap.

3. The pre-filter water apparatus of claim 2, wherein the water inlet unit is positioned at one-third the length of the water holding unit from a top of the water holding unit.

4. (canceled)

5. The pre-filter water apparatus of claim 2, wherein the sediment drain connects to a foot tube by means of a pipe thread.

6. The pre-filter water apparatus of claim 1, wherein the water inlet unit includes a water inlet opening to connect the water inlet unit to the external water supply source by means of a pipe thread.

7. The pre-filter water apparatus of claim 1, wherein the water outlet unit includes a water outlet opening to connect the water outlet unit to the water purification unit by means of a pipe thread.

8. (canceled)

9. (canceled)
